(19) United States
(12) Patent Application Publication
(10) Pub. No.: US 2012/0023074 A1
(43) Pub. Date: Jan. 26, 2012

(54) SCALABLE RULE-BASED DATA SYNCHRONIZATION SYSTEMS AND METHODS

(75) Inventors: Tsehsin Jason Liu, Wellesley, MA (US); Eric Greene, Colorado Springs, CO (US); Vazir Ahamed, Chennai (IN)

(73) Assignee: VERIZON PATENT AND LICENSING, INC., Basking Ridge, NJ (US)

(21) Appl. No.: 12/841,352

(22) Filed: Jul. 22, 2010

(51) Int. Cl. G06F 17/30; G06F 15/173; G06F 15/16

(52) U.S. Cl. 707/694; 709/206; 709/224; 707/E17.007

(57) ABSTRACT

Exemplary scalable, rule-based data synchronization systems and methods are disclosed. An exemplary method includes at least one computing device executing a database trigger process in response to a database trigger event, the database trigger process including writing a general data message to a general message repository. The method further includes the at least one computing device executing an independent process including monitoring the general message repository, detecting the general data message in the general message repository, and processing, in response to the detecting of the general data message in the general message repository, the general data message in accordance with a predefined set of rules. Corresponding systems and methods are also disclosed.

### BACKGROUND INFORMATION

A typical enterprise computing environment includes multiple heterogeneous and distributed database systems supporting a variety of different enterprise organizations and business purposes. For example, many enterprises, such as businesses and the like, maintain different backend database systems to support customer billing, sales, accounting, marketing, inventory, ordering, repairs, service, procurement, etc. Further, many enterprises are the result of a merger of two or more predecessor organizations, each with their own set of heterogeneous and distributed database systems.

There are many reasons why multiple heterogeneous and distributed database systems may exist within an enterprise. Where database systems were created using different technologies or different data models, there may be considerable disruption to the enterprise, not to mention considerable time and expense, in migrating multiple database systems to a common technology platform. In addition, database systems that support different enterprise organizations may be operated in accordance with different business purposes that are not readily reconcilable. Moreover, migration of data may disrupt an enterprise's ability to provide meaningful and consistent information to customers while also maintaining the integrity of the data. For instance, a customer may be granted access to certain account data, but when the account data is migrated from one technology platform to another at the backend, the customer may no longer be able to access the account data as it existed before the migration. Such an occurrence may be inconvenient or even unacceptable to the customer. These and other concerns associated with data migration may delay or prevent an enterprise from migrating data. Thus, although migration of data may be desirable to an enterprise, certain concerns, including difficulties in maintaining data integrity and consistency of data presentation, for example, may prevent an enterprise from migrating data.

Due to the above-described concerns associated with data migration, an enterprise may choose to integrate data maintained by different backend database systems into a set of integrated data that is mapped to and synchronized with the data maintained by the different backend database systems in accordance with business rules of the enterprise. The set of integrated data may be maintained in a data integration database. However, conventional database technologies place limitations on the scalability of such data integration systems. For example, as backend database systems increase in number and/or complexity, business logic used to maintain integrated data in a data integration database (e.g., logic used to check data integrity and/or to selectively route data synchronization messages) in accordance with business rules of the enterprise becomes increasingly complex to the extent that the performance of the data integration database is adversely affected. For instance, business logic is commonly built into one or more database trigger processes. As the business logic increases in complexity (e.g., due to an increased number of backend database systems), processing times for the database trigger processes increase. The increased trigger processing times adversely impact database performance at least because other database processes (e.g., subsequently triggered database trigger processes) are forced to wait longer for the execution of the database trigger processes to complete.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical reference numbers designate identical or similar elements.

FIG. 1 illustrates an exemplary data management system according to principles described herein.

FIG. 2 illustrates exemplary components of a data integration subsystem and backend data subsystems included in the data management system of FIG. 1 according to principles described herein.

FIG. 3 illustrates exemplary components of the data integration subsystem included in the data management system of FIG. 1 according to principles described herein.

FIG. 4 illustrates the exemplary components of FIG. 3 configured for processing outgoing data messages according to principles described herein.

FIG. 5 illustrates an exemplary general data message according to principles described herein.

FIG. 6 illustrates an exemplary routing rule according to principles described herein.

FIG. 7 illustrates an exemplary destination-specific data message according to principles described herein.

FIG. 8 illustrates an exemplary data processing method according to principles described herein.

FIG. 9 illustrates an exemplary data integration method according to principles described herein.

FIG. 10 illustrates an exemplary computing device according to principles described herein.

### DETAILED DESCRIPTION OF PREFERRED EMBODIMENTS

Exemplary scalable, rule-based data synchronization systems and methods are disclosed. In certain embodiments, the exemplary systems and methods described herein may be implemented or otherwise used to synchronize data in a data management system in a manner that is scalable and accommodating of complex and/or changing rules configured to govern the synchronization of data. For example, as described in more detail herein, the exemplary systems and methods may be employed in a data management system that includes a data integration subsystem configured to maintain integrated data that is mapped to and synchronized with local data maintained by a plurality of backend data subsystems. Such an implementation is illustrative only. The exemplary systems and methods described herein may be utilized in other implementations in which data is synchronized (e.g., across separate databases) in accordance with a predefined set of rules.

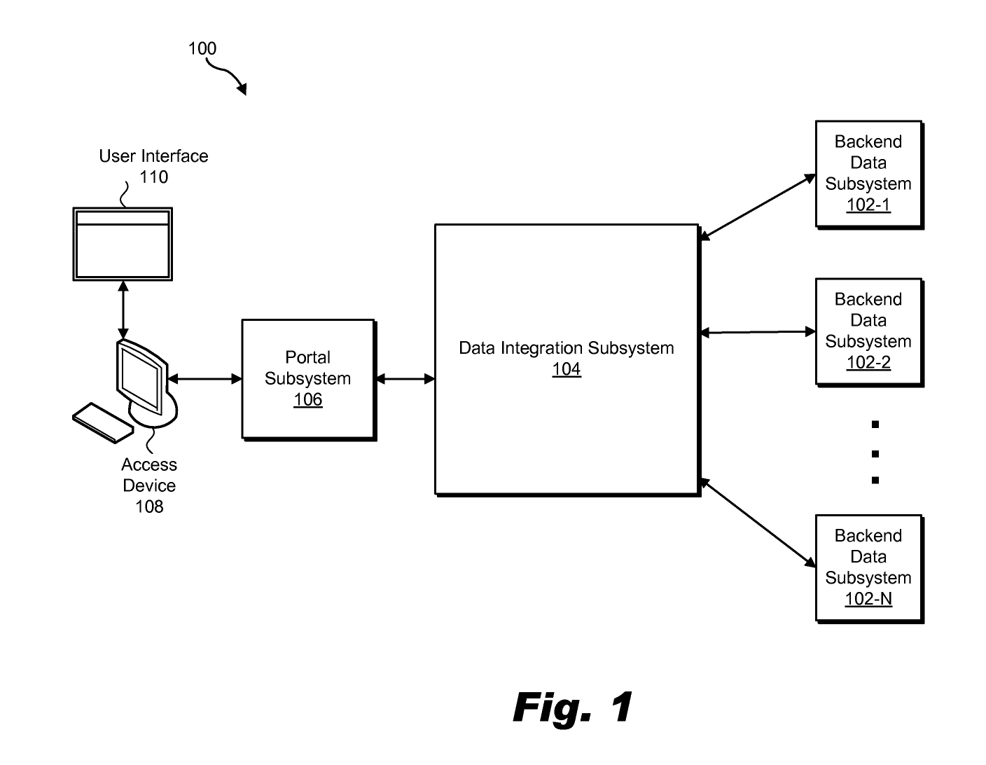

FIG. 1 illustrates an exemplary data management system 100 (or simply “system 100”). As shown in FIG. 1, system 100 may include backend data subsystems 102-1 through 102-N (collectively “backend data subsystems 102”) communicatively coupled to a data integration subsystem 104. System 100 may further include a portal subsystem 106 communicatively coupled to data integration subsystem 104 and configured to selectively communicate with an access device 108 that is configured to present a user interface 110 to a user of the access device 108.

Components of system 100 may communicate with one another using any suitable communication technologies, devices, media, and protocols supportive of data communications, including, but not limited to, the Internet, intranets, local area networks, other communications networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, data bus technologies, and other suitable communications technologies. In certain implementations, at least a subset of communications between backend data subsystems 102 and data integration subsystem 104 may be carried out as described in U.S. patent application Ser. No. 11/443,364, entitled “Asynchronous Data Integrity for Enterprise Computing,” filed May 31, 2006 and incorporated herein by reference in its entirety.

While an exemplary system 100 is shown in FIG. 1, the exemplary components illustrated in FIG. 1 are not intended to be limiting. Other components and/or configurations of components may be used in other implementations. Exemplary components of system 100 will now be described in additional detail.

Backend data subsystems 102 may be configured to store and maintain electronic data that may be referred to as “local data.” Backend data subsystems 102 may be heterogeneous and/or may maintain heterogeneous data. For example, one or more of the backend data subsystems 102 may store local data according to local data schemas that are different from the local data schemas used by other backend data subsystems 102. For instance, backend data subsystem 102-1 may employ a first data schema, backend data subsystem 102-2 may employ a second data schema, and backend data subsystem 102-N may employ another data schema. As used herein, a “data schema” or “data schema type” may refer to a definition of one or more properties, technologies, templates, frameworks, formats, data models, and/or business rules that may be used to represent data. For example, a data schema may provide a framework for naming, storing, and accessing different elements of information. As another example, local data may be maintained in accordance with different business rules across locate data subsystems 102. Accordingly, each of the backend data subsystems 102 may be configured to manage its local data in accordance with a particular set of business rules that is specific to an organization within an enterprise.

Data integration subsystem 104 may be configured to maintain electronic data that may be referred to as “integrated data.” Integrated data may include any data maintained by data integration subsystem 104 and that is mapped from the local data maintained by the backend data subsystems 102. Integrated data may be mapped from the local data and stored at data integration subsystem 104 in any manner suitable for maintaining data integrity between the integrated and local data, including preserving behaviors, relationships, and properties of the local data in the integrated data. A mapping between local data and integrated data may be defined based on local data models, properties of the local data, and/or as may serve a particular implementation. A mapping between local data and integrated data may also be based on a predefined integrated data model. Accordingly, a mapping can represent any definition of a set of one or more relationships between local data and integrated data that can suitably preserve the properties of the local data (or at least certain select properties of the local data) in the integrated data and that is in accordance with an integrated data model.

A mapping may be defined in any acceptable manner, including by one or more persons (e.g., system administrators or operators) manually defining a mapping based on the properties and specifications of local data stored in backend data subsystems 102 and on an integrated data model. Alternatively or additionally, automatic mapping operations may be performed to define a mapping based on a predefined mapping heuristic. A defined mapping may be used in subsequent processing for automatically translating between and/or synchronizing the local data and the integrated data. For example, mappings may be used to map integrated data to local data to fulfill data access requests. In certain implementations, integrated data may be mapped to local data in any of the ways described in U.S. patent application Ser. No. 11/443,363, entitled “Systems and Methods for Managing Integrated and Customizable Data,” filed May 31, 2006, and incorporated herein by reference in its entirety. A mapping may be defined based on the exemplary global data model described in the same U.S. patent application Ser. No. 11/443,363.

Access to at least a subset of the integrated data may be selectively provided for external user access. In addition, external user access to local data may be gained by way of the integrated data. This may allow an external user (e.g., a user external to an internal party that manages data integration subsystem 104 and backend data subsystems 102) to access, manage, and/or utilize integrated data maintained by data integration subsystem 102, and consequently local data maintained by backend data subsystems 102. To this end, portal subsystem 106 may be configured to function as an access portal to provide external access to integrated data, as well as to local data by mapping integrated data to local data.

Access device 108 may provide external access to portal subsystem 106 and consequently to data integration subsystem 104 via the portal subsystem 106. Accordingly, a user may utilize access device 108 to communicate with portal subsystem 106 and access and manage integrated data. Access device 108 may include any device physically or remotely accessible to one or more users and that allows a user to provide input to and receive output from portal subsystem 106. For example, access device 108 may include, but is not limited to, one or more desktop computers, laptop computers, tablet computers, personal computers, personal data assistants, cellular telephones, satellite pagers, wireless internet devices, embedded computers, video phones, mainframe computers, mini-computers, programmable logic devices, vehicular computers, Internet-enabled devices, and any other devices capable of communicating with portal subsystem 106. Access device 108 may also include or interact with various peripherals such as a terminal, keyboard, mouse, screen, printer, stylus, input device, output device, or any other apparatus that can help a user interact with access device 108.

Access device 108 may be configured to generate and display user interface 110 to a user of access device 108. User interface 110 may be configured to present representations of integrated data, local data, and one or more data management tools configured to enable a user to externally access and use the integrated data and/or the local data. In certain examples, user interface 110 may comprise one or more graphical user interfaces (“GUIs”) configured to display information and receive input from users. In certain exemplary implementations, user interface 110 includes a web browser, such as Internet Explorer, Mozilla Firefox, Safari, and the like. However, user interface 110 is not limited to web-based and/or graphical implementations and may include many different types of user interfaces that enable users to utilize access device 108 to communicate with portal subsystem 106. In some implementations, for example, user interface 110 may include a voice interface capable of receiving voice input from and/or providing voice output to a user.

A single access device 108 is shown in FIG. 1 for illustrative purposes only. It will be recognized that one or more access devices 108 may communicate with portal subsystem 106 and gain external access to integrated data and/or local data by way of portal subsystem 106.

External access to integrated data and/or local data may be based on permissions settings maintained by portal subsystem 106. Permissions settings may be stored in portal subsystem 106 or at another location. Portal subsystem 106 may access and use permission settings to determine whether users have permission to access certain integrated and/or local data, or to determine the specific integrated and/or local data accessible to users. This allows portal subsystem 106 to selectively provide users or groups of users with access to different sets of integrated and/or local data in accordance with the permissions settings. Permissions settings may be included in one or more user profiles maintained by portal subsystem 106 and/or data integration subsystem 104. The user profiles may correspond to users associated with an external party such as an enterprise customer. Portal subsystem 106 may be configured to maintain user permissions settings in any of the ways described in U.S. patent application Ser. No. 11/584,098, entitled “Integrated Data Access” and filed Oct. 20, 2006, U.S. patent application Ser. No. 11/584,111, entitled “Integrated Application Access” and filed Oct. 20, 2006, and/or the previously mentioned U.S. patent application Ser. No. 11/443,363 filed on May 31, 2006, each of which is herein incorporated by reference in its entirety.

In certain examples, integrated and local data may include customer data. To illustrate, backend data subsystems 102 may be operated by an internal party, and the local data maintained by the internal party may be representative of one or more external parties such as customers of the internal party. As used herein, “internal party” may refer to any person or organization (e.g., a service provider such as a telecommunications service provider) maintaining data, and “external party” or “external user” may refer to any person or organization that is external to (i.e., not part of) the internal party. Hence, local data may include, but is not limited to, data records representative of customer entities and customer accounts (e.g., service subscribers and subscription accounts), as well as data representing one or more relationships between the customer entities and accounts. As an example, an external party may include a customer of the internal party, such as a subscriber to services provided by the internal party. The internal party (e.g., a telecommunications enterprise) may maintain data associated with the external party and/or related to the providing of one or more services (e.g., telecommunications services) to the external party. The internal party may maintain local customer-related data in backend data subsystems 102.

Backend data subsystems 102 may be associated with different organizations and/or business purposes of the internal party (e.g., an enterprise), including customer billing, sales, accounting, marketing, inventory, ordering, repairs, service, procurement, or other organizations, purposes, or operations of the internal party. In some examples, differences between the different organizations and/or business purposes of the internal party may contribute to the heterogeneous nature of backend data subsystems 102. Backend data subsystems 102 may be geographically consolidated or distributed across different geographic areas.

Data integration subsystem 104 may be configured to maintain integrated data such that over time the integrated data accurately represents local data stored in backend data subsystems 102. To this end, updates to local data may be carried through to integrated data and updates to integrated data may be carried through to local data in accordance with one of more predefined mappings between the integrated and local data. The updates may synchronize integrated data with local data.

To effectuate updates to the integrated and/or local data, one or more data messages carrying data representative of the updates may be carried between data integration subsystem 104 and one or more backend data subsystems 102. Such data messages may be referred to as data “update” or “synchronization” messages. A backend data subsystem 102 from which a data message is received by data integration subsystem 104 may be referred to as an “upstream” backend data subsystem 102, and a backend data subsystem 102 to which a data message is sent by data integration subsystem 104 may be referred to as a “downstream” backend data subsystem 102. Backend data subsystems 102 may function as upstream, downstream, or both upstream and downstream backend data subsystems 102.

Data messages carried between data integration subsystem 104 and backend data subsystems 102 may be backend-specific data messages. For example, a data message may be formatted specific to a backend data subsystem 102. Data integration subsystem 104 may be configured to translate data messages from a general data message format to one or more backend-specific data message formats used by backend data subsystems 102 and vice versa. Accordingly, data integration subsystem 104 may be configured to translate a received backend-specific data message to an incoming general data message and an outgoing general data message to a backend-specific data message to be transmitted to a backend data subsystem 102.

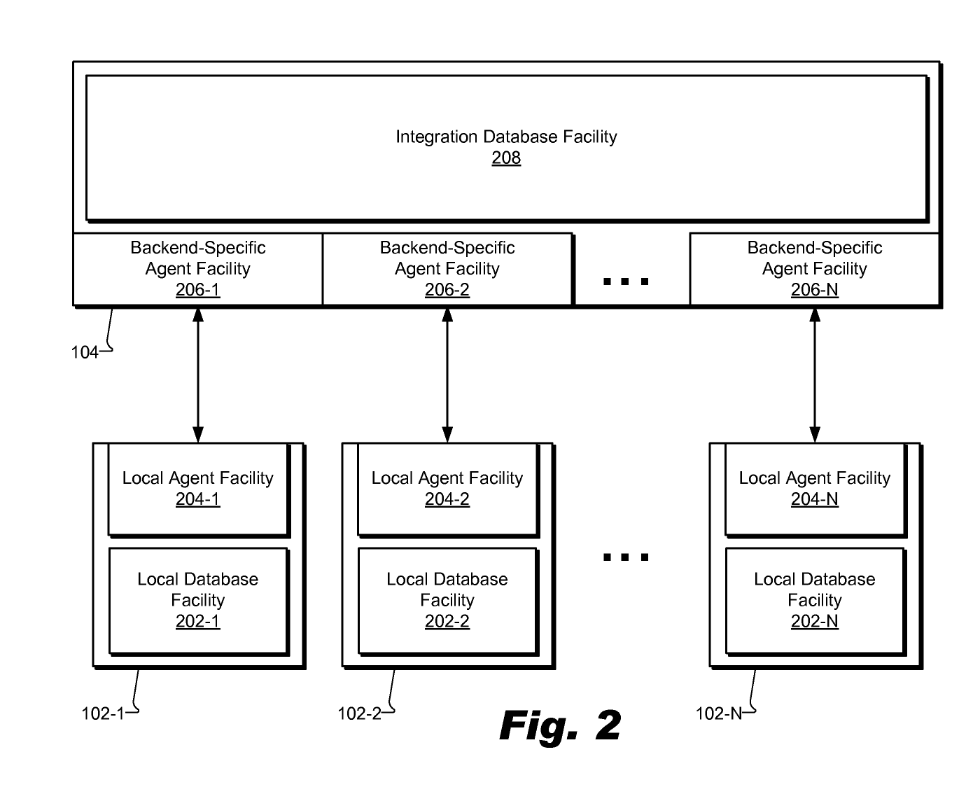

To illustrate, FIG. 2 shows exemplary components of data integration subsystem 104 and backend data subsystems 102. As shown, backend data subsystems 102 may include respective local database facilities 202 (e.g., local database facilities 202-1 through 202-N) and respective local agent facilities 204 (e.g., local agent facilities 204-1 through 204-N). Local database facilities 202 may be configured to perform one or more database processes to maintain local data for backend data subsystems 102 in any of the ways described herein. Local agent facilities 204 may be configured to communicate with respective local database facilities 202 to facilitate forwarding of data messages from local database facilities 202 to data integration subsystem 102 and from data integration subsystem 102 to local database facilities 102.

Data integration subsystem 104 may include backend-specific agent facilities 206 (e.g., backend-specific agent facilities 206-1 through 206-N) configured to communicate with respective local agent facilities 204 of backend data subsystems 102 as shown in FIG. 2. For example, each backend-specific agent facility 206 may coordinate with a corresponding local agent facility 204 to communicate data messages between integration data subsystem 104 and the corresponding backend data subsystem 102. In certain examples, the coordination between backend-specific agent facilities 206 and local agent facilities 204 may be used to translate data messages between a general data model used by data integration subsystem 104 and one or more local data models used by local data subsystems 102. In certain implementations, data translation operations may be carried out by backend-specific agent facilities 206 and local agent facilities 204 in any of the ways and using any of the technologies described in the previously mentioned and incorporated U.S. patent application Ser. No. 11/443,364 filed on May 31, 2006.

Data integration subsystem 104 may further include an integration database facility 208 communicatively coupled to backend-specific agent facilities 206. Integration database facility 208 may be configured to perform one or more database processes to maintain integrated data in a database of data integration subsystem 104 in any of the ways described herein. For example, integration database facility 208 may perform one or more database processes to check data integrity of data included in one or more incoming data messages (e.g., data messages received from portal subsystem 106 and/or one or more backend data subsystems 102) and/or to generate and/or selectively route outgoing data messages from data integration subsystem 104 to one or more backend data subsystems 102. In certain examples, such data processes may be executed as part of synchronizing integrated data maintained by data integration subsystem 104 with local data maintained by backend data subsystems 102.

Integration database facility 208 may be configured to perform one or more database processes, including processes performed as part of data synchronization, in accordance with one or more sets of predefined rules, which may be maintained by integration database facility 208. A set of predefined rules may be maintained as data logic representative of one or more business rules that govern how data is to be maintained by integration database facility 208. The predefined rules may be defined to represent any business rules as may serve a particular implementation.

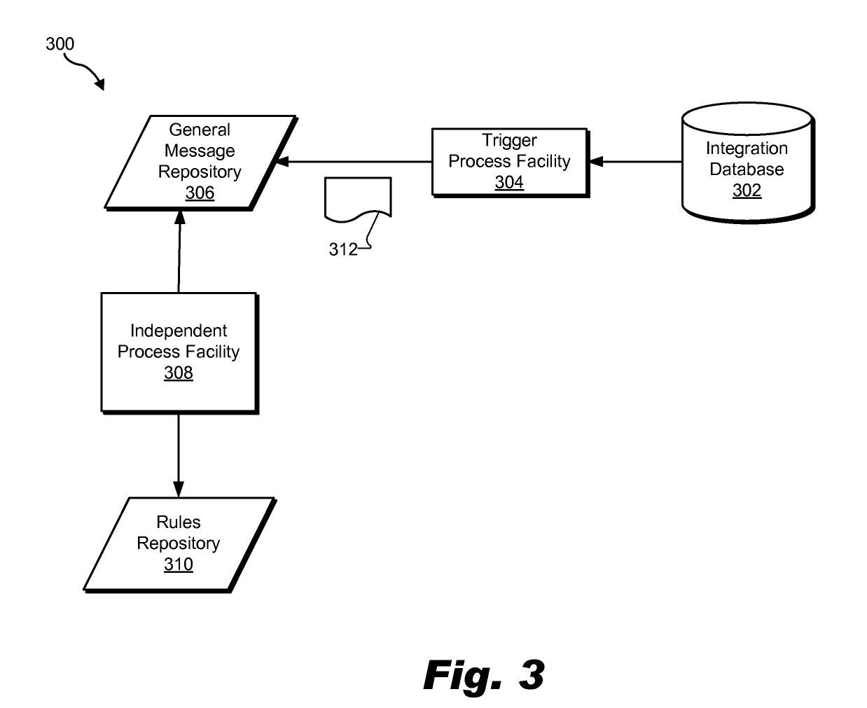

Data integration subsystem 104 may be configured to facilitate scalability and efficiency integration database facility 208 of system 100. To illustrate, FIG. 3 shows additional exemplary components of data integration subsystem 104, which components may include an integration database 302, a trigger process facility 304, a general message repository 306, an independent process facility 308, and a rules repository 310 configured to communicate with one another as shown in FIG. 3. One or more of the components shown in FIG. 3 may be implemented within integration database facility 208 and/or elsewhere within data integration facility 104.

Integration database 302 may maintain integrated data within data integration subsystem 104. The integrated data may be maintained in integration database 302 in any suitable form and using any suitable database technologies. In certain implementations, the integrated data may be maintained in data elements such as database tables.

Integration database 302 may be configured to detect one or more predefined database triggers. The database triggers may be defined to include any events occurring within or in relation to integration database 302. For example, database triggers may be defined to include one or more data updates and/or data update requests (e.g., add, insert, modify, delete, etc.) occurring within or in relation to integration database 302.

Database trigger process facility 304 may be configured to execute a database trigger process in response to a detection of an occurrence of a database trigger within integration database 302. For example, trigger process facility 304 may execute a trigger process in response to a detected update to a particular data element (e.g., a data table) and/or a particular part of a data element (e.g., a column within a data table) in integration database 302.

Execution of the trigger process may include writing a general data message to general message repository 306. An exemplary general data message is shown as general data message 312 in FIG. 3. General data message may be formatted in accordance with a general data messaging format utilized by data integration subsystem 104. Any suitable data messaging format may be utilized, including an extensible markup language (“XML”) messaging format or the like. General data message 312 may include data representative of the database trigger event (e.g., an update to a column of a data table) that triggers execution of the trigger process.

The execution of the trigger process may complete directly following the writing of general data message 312 to general message repository 306. In certain implementations, the trigger process includes no processing steps other than the writing of general data message 312 to general message repository 306. Such a configuration of the trigger process may facilitate scalability and/or efficiency of integration database 302. For instance, by limiting the processing steps of the trigger process (e.g., to simply writing general data message 312 to general message repository 306), the trigger process may complete quickly and with a constant overhead (e.g., a single write operation), thereby allowing subsequent trigger processes to initiate and execute without having to wait for execution of complex logic (which may have variable overhead) within the trigger process be completed. This is in contrast to a conventional trigger process having decision-making logic integrated therein. Such a conventional trigger process may have variable execution overhead and may introduce delays into a database. Moreover, such delays may expand in proportion to increases in complexity of decision-making logic integrated in a conventional trigger process.

General message repository 306 may store one or more general data messages (e.g., general data message 312), which may be written to general message repository 306 by one or more trigger processes. The general data messages may be stored in general message repository 306 in any suitable way. In certain implementations, general message repository 306 may be implemented as a data element (e.g., a data table) in integration database 302.

Independent process facility 308 may be configured to execute an independent process that monitors general message repository 306 to detect one or more general data messages having one or more predefined attributes. For example, the independent process may monitor general message repository 306 for general data messages that are incoming data messages, outgoing data messages, other types of data messages, associated with one or more particular data elements (e.g., a particular data table) of integration database 302, are associated with one or more parts of one or more data elements (e.g., a particular column in a particular data table) of integration database 302, and/or are associated with any other predefined set of attributes.

Accordingly, the independent process may detect general data message 312 in general message repository 306. In response to this detection, the independent process may process general data message 312 in accordance with a predefined set of rules included in rules repository 310. The set of predefined rules in rules repository 310 may represent one or more business rules of an enterprise. In certain implementations, rules repository 310 may be maintained as a data element (e.g., a data table) in integration database 302. Storage of the rules as a data element in integration database 302 may allow one or more rules in rules repository 310 to be dynamically updated without interrupting operation of integration database 302 and/or data integration subsystem 104. Additionally or alternatively, storage of the rules as a data element in integration database 302 may facilitate efficient access to the rules by the independent process.

The independent process may be executed independently of a trigger process executed by trigger process facility 304. In certain implementations, for example, the independent process may include a background process that is executed independently of the trigger process. The independence of the independent process from the trigger process may allow the trigger process to complete execution efficiently and with constant overhead such that subsequent trigger processes may be initiated and completed with minimal delay. In certain examples, a subsequent trigger process may be initiated, executed, and/or completed before execution of the independent process (e.g., execution of the independent process directed at general data message 312) is completed. Accordingly, trigger processes of integration database 302 may continue to be completed without being delayed by execution by independent process facility 308 of logic represented as rules in rules repository 310. Such an offloading of execution of logic representative of business rules from a trigger process to an independent process, which may be executed in parallel of one or more trigger processes, may facilitate scalable, rules-based synchronization of data between components of data management system 100.

In certain implementations, the independent process may be implemented as a stored procedure of integration database 302. This may provide the independent process with efficient access to rules data maintained in rules repository. The independent process may be implemented in any other suitable way in other implementations. For example, the independent process may be implemented as one or more sets of computer-executable instructions (e.g., a Java program) that may be executed within integration database 302 and/or external of integration database 302.

To further illustrate the independence of the independent process from a trigger process, an example will now be described. In the present example, a trigger process may be associated with a specific data element in integration database 302. An update to the data element in integration database 302 may trigger execution of the trigger process. In response, the trigger process may write general data message 312 representative of the update to the data element in integration database 302 to general message repository 306 and complete directly after general data message 312 is written to general message repository 306.

Subsequently, an additional update to the data element in integration database 302 may trigger execution of another database trigger process. In response, the additional trigger process may write an additional general data message representative of the additional update to the data element in integration database 302 to general message repository 306 and complete directly after the additional general data message is written to general message repository 306.

The execution of the additional trigger process may be completed without having to wait for execution of complex decision-making logic to be completed by the initial trigger process or the independent process. In addition, by restricting the processing steps of the initial trigger process to a single, constant overhead step, delay time between the executions of trigger processes associated with the same data element may be minimized, thereby facilitating scalability and/or efficiency of integration database 302. In contrast, a conventional database trigger process may include complex decision-making logic representative of business rules, which logic is typically forced, by a conventional database, to be executed before a subsequent trigger process associated with the same data element may be executed. In such conventional configurations, expandable inefficiencies are introduced in integration database 302 in proportion to the complexity of the logic in the conventional trigger process.

Trigger process facility 304, general message repository 306, independent process facility 308, and rules repository 310 may be configured to handle any specific updates and/or types of updates associated with integration database 302. For example, trigger process facility 304, general message repository 306, independent process facility 308, and rules repository 310 may be configured to handle incoming data messages, outgoing data messages, or both incoming and outgoing data messages associated with integration database 302. Such messages may include synchronization messages used to synchronize integrate data with local data.

Incoming data messages may include any data messages associated with updates to be made to integrated data in integration database 302, or with updates that have been made to integrated data in integration database 302 and are to be checked for data integrity. Incoming data messages may be originated by portal subsystem 106 and/or one or more backend data subsystems 102. For such incoming data messages, the independent process may be configured to perform one or more operations to check the data integrity of the incoming data messages in accordance with a predefined set of rules that includes one or more data integrity checking rules. The data integrity checking rules may be defined in any way suitable for checking for integrity of data. For example, the rules may be configured to check whether an incoming data message came from an acceptable source that has permission to initiate a proposed update.

Outgoing data messages may include any data messages associated with updates to be propagated from data integration subsystem 104 to local data maintained by backend data subsystems 102 (e.g., to propagate an update in the integrated data to the appropriate local data). For such outgoing data messages, the independent process may be configured to perform one or more operations to selectively route the outgoing data messages to one or more destinations (e.g., one or more backend data subsystems 102) in accordance with a predefined set of rules that includes one or more routing rules. The routing rules may be defined in any way suitable for selecting appropriate destinations to which outgoing data messages will be routed. For example, the rules may be configured for use in determining to which backend data subsystems 102 to route data representative of a particular update in the integrated data. In addition, the rules may be configured for use in selecting and/or generating appropriate data (e.g., backend-specific data) to be transmitted to the selected backed data subsystems 102.

In certain implementations, multiple sets of a trigger process facility, general message repository, independent process facility, rules repository, or combinations or sub-combinations thereof may be configured to handle different updates and/or types of updates associated with integration database 302. To illustrate, in certain exemplary implementations, a first set of a trigger process facility, general message repository, independent process facility, and rules repository may be configured to handle incoming data messages associated with integration database 302, and a second set of a trigger process facility, general message repository, independent process facility, and rules repository may be configured to handle outgoing data messages associated with integration database 302. Alternatively, a single set of a trigger process facility and general message repository may be used to handle incoming and outgoing data messages associated with integration database 302, a first independent process facility may be configured to detect incoming data messages in general message repository 306 and process the detected incoming data messages in accordance with a first set of predefined rules (e.g., data integrity checking rules), and a second independent process facility may be configured to detect outgoing data messages in general message repository 306 and process the detected outgoing data messages in accordance with a second predefined set of rules (e.g., routing rules). Such exemplary configurations are illustrative only. Other configurations may be employed in other implementations.

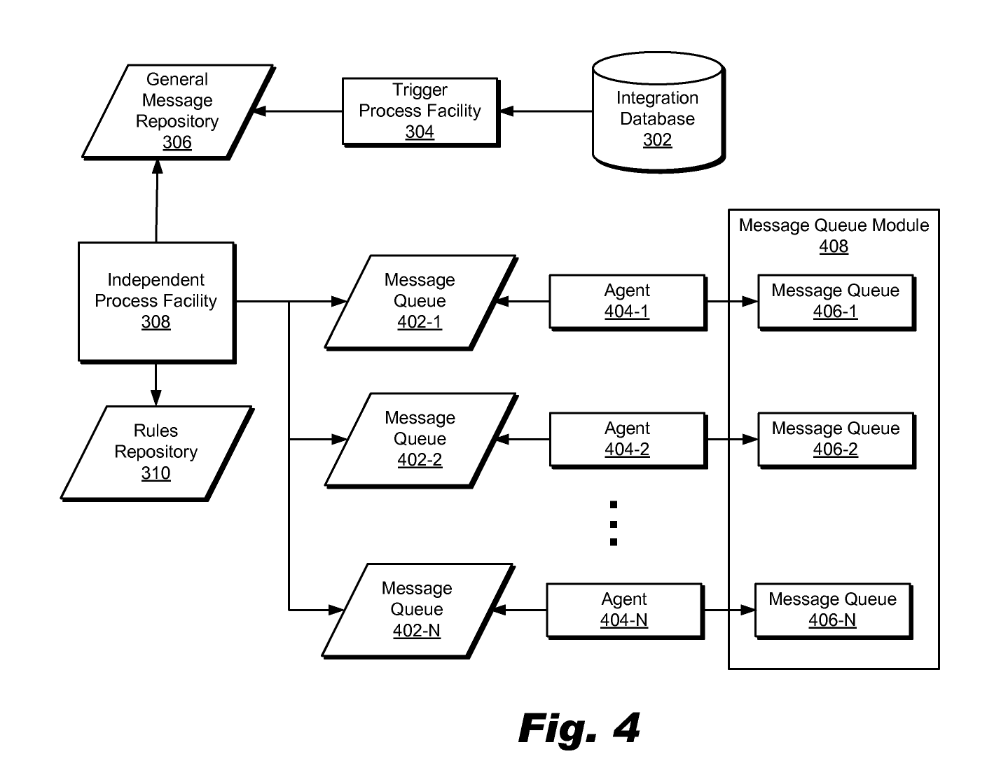

To further illustrate operation of the exemplary components shown in FIG. 3, FIG. 4 illustrates the exemplary components of FIG. 3 configured for processing outgoing data messages. An occurrence of an exemplary database trigger event and subsequent operation of components shown in FIG. 4 will now be described.

A database trigger event may occur in integration database 302. For example, a data element and/or a particular part of a data element in integration database 302 may be updated in accordance with an update request received from portal subsystem 106 or one of backend data subsystems 102. To illustrate, a new data element representative of a customer subscription may be inserted into integration database 302 in response to user input provided to portal subsystem 106 by a user having a portal user identifier of “USER2.”

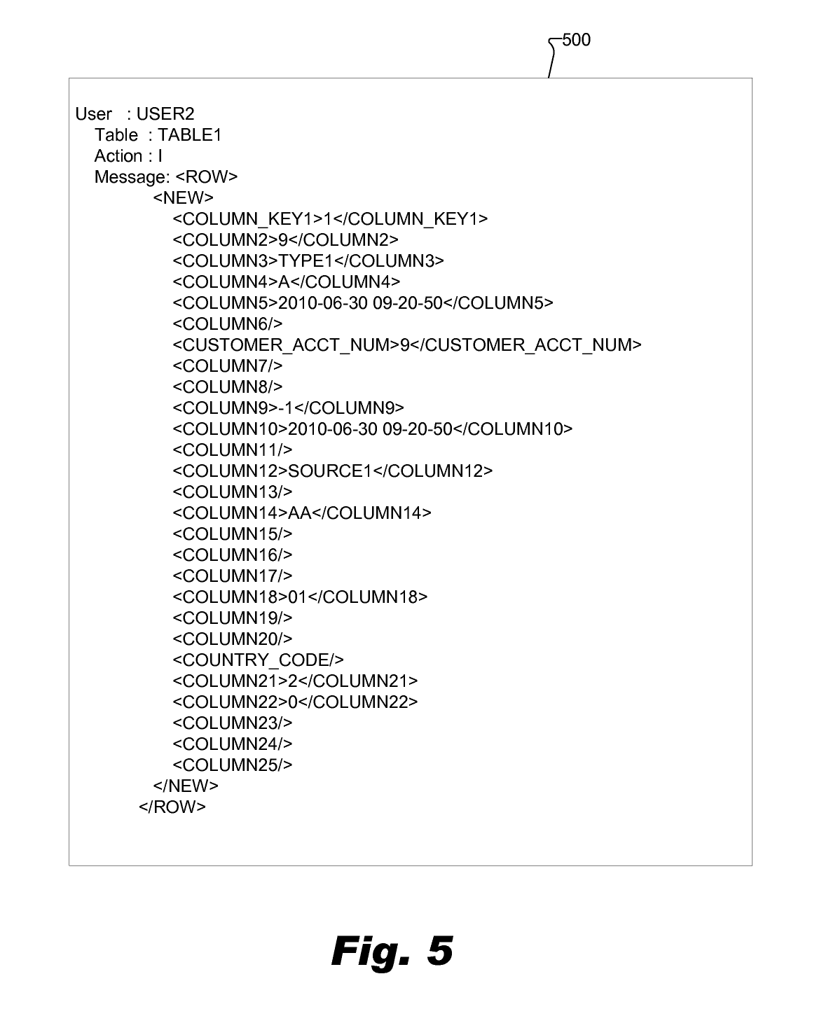

In response to the database trigger event, trigger process facility 304 may execute a trigger process that may create and write a general data message representative of the update in integration database 302 to general message repository 306. FIG. 5 illustrates an exemplary general data message 500 that may be written by the trigger process to general message repository 306 in response to an insertion of the new data element representative of the customer subscription provided by user “USER2.” As shown in FIG. 5, general data message 500 may include a “user” field indicating that the update is associated with user “USER2,” a “table” field indicating that the update is associated with a data table identified as “TABLE1” in integration database 302, and an “action” field indicating that the action is an insertion (“I”) of the new data element into the “TABLE1” data table. General data message 500 may also include a “message” field populated with data representative of the new subscription. In FIG. 5, the content of the “message” field is in XML format. However, this is illustrative only. Other data formats such as a pipelined, a comma-separated, or other message format may be used in other embodiments.

Returning to FIG. 4, an independent process executed by independent process facility 308 to monitor general message repository 306 may detect the general data message (e.g., general data message 500) in general message repository 306. In response to the detection, the independent process, which may be implemented as a routing agent facility, may process the general data message in accordance with a predefined set of rules (e.g., routing rules) contained in rules repository 310. The processing may include determining, based on content in the general data message and on the set of rules, one or more destinations (e.g., one or more backend data subsystems 102) to which to route the general data message. Additionally, the processing may include determining, based on content in the general data message and on the set of rules, what data to send to the determined destinations.

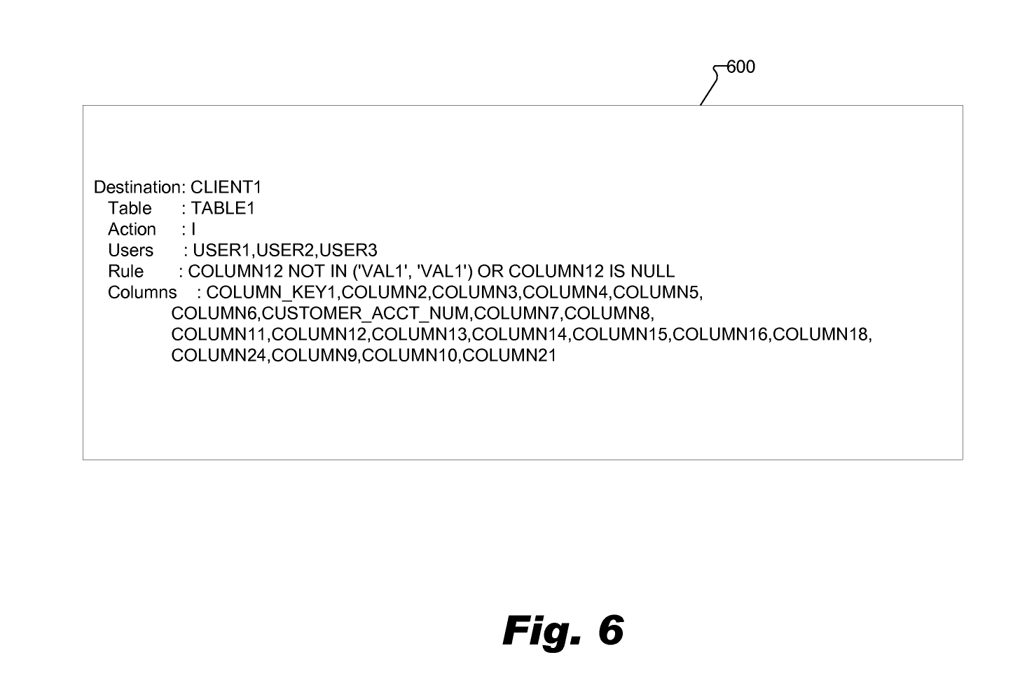

To illustrate, FIG. 6 shows an exemplary routing rule 600 that may be included in rules repository 310 and used by an independent process to process the general data message. Routing rule 600 indicates that an insertion of a data element (e.g., “action” field has a value of “I”) in a data table identified as “TABLE1” (“Table” field has a value of “TABLE1”) by a user having a user identifier value of “USER1,” “USER2,” or “USER3” are to be sent to a particular destination (a “destination” field has a value of “CLIENT1,” which is an identifier of a destination such as a particular one of the backend data subsystems 102), as long as the insertions were not received from certain sources (e.g., a “rule” field specifies that the rule is satisfied if an insertion did not originate from a backend data subsystem having an identifier value of “VAL1,” “VAL2,” or “NULL”). Accordingly, based on the information in routing rule 600 and content in the general data message, the independent process may determine to route the general data message to the destination specified in routing rule 600 when the conditions specified in routing rule 600 are satisfied by the general data message. The rule conditions specified in routing rule 600 are satisfied by general data message 500 shown in FIG. 5, which indicates in “COLUMN12” of the “message” field that a source is a backend data subsystem having an identifier value of “SOURCE1.”

Routing rule 600 may also indicate the data to be sent to the determined destination. For example, routing rule 600 includes a “columns” field specifying particular data columns to be sent to the determined destination. Based on this information, the independent process may generate a destination-specific data message for the determined destination based on the contents of routing rule 600 and the general data message.

To illustrate, general data message 500 shown in FIG. 5 includes a list of data column identifiers and values within the “message” field. For example, a column identified as “COLUMN_KEY1” has a value of “1” in general data message 500. The “columns” field of routing rule 600 shown in FIG. 6 specifies which columns are to be included in a destination-specific data message generated by the independent process from the general data message. The “columns” field of routing rule 600 further indicates an order in which the columns are to be included in the destination-specific data message. Accordingly, the independent process may use “columns” field of routing rule 600 as a template for retrieving data from the general data message and inserting the retrieved data in a destination-specific data message. In the illustrated example, the independent process will retrieve and insert values for columns labeled as “COLUMN_KEY1,” “COLUMN2,” “COLUMN3,” “COLUMN4,” “COLUMN5,” “COLUMN6,” “CUSTOMER_ACCT_NUM,” “COLUMN7,” “COLUMNS,” “COLUMN11,” “COLUMN12,” “COLUMN13,” “COLUMN14,” “COLUMN15,” “COLUMN16,” “COLUMN18,” “COLUMN24,” “COLUMN9,” “COLUMN10,” and “COLUMN21,” in that order, into the destination-specific data message.

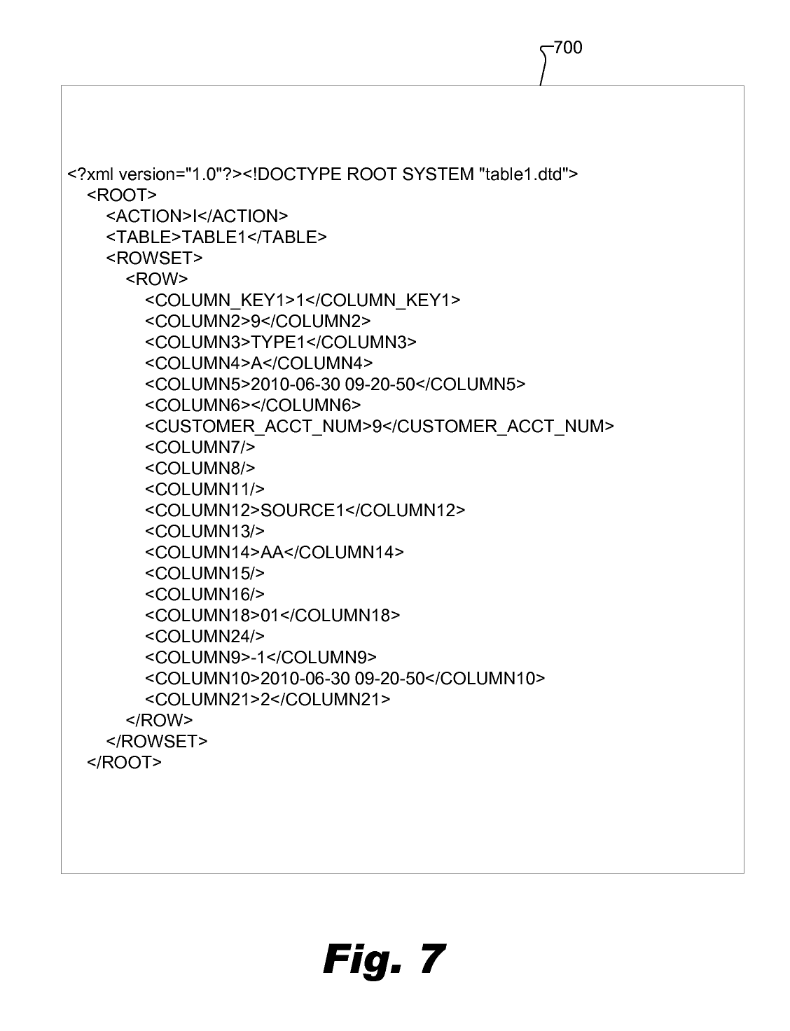

FIG. 7 illustrates an exemplary destination-specific data message 700 that may be generated by an independent process. As shown in FIG. 7, the output columns included in message 700 include only the columns specified in the column list of routing rule 600. Message 700 may be in XML data format, pipelined data format, column-separated data format, or in any other suitable format.

The independent process may similarly generate one or more other destination-specific data messages for one or more other determined destinations in accordance with one or more routing rules in rules repository 310. For example, rules repository 310 may include multiple rules associated with multiple potential destinations. In processing a general data message detected in general message repository 306, the independent process may determine which of the multiple rules included in rules repository 310 to apply to the general data message. For each rule that is determined to apply to the general data message, the independent process may generate a destination-specific data message based on the content of the general data message and the applicable rule as described above.

The independent process may output data representative of one or more destination-specific data messages generated by the independent process. For example, the independent process may generate and output destination-specific data messages targeted for distinct destinations such as one or more backend data subsystems 102. The outputting of a generated destination-specific data message may include writing data representative of the destination-specific data message to a message queue associated with a determined destination. Returning to FIG. 4, for example, the independent process may write destination-specific data messages to message queues 402 (e.g., message queues 402-1 through 402-N) associated with determined destinations. For instance, the independent process may write a first destination-specific data message to message queue 402-1, a second destination-specific data message to message queue 402-2, in the third destination-specific data message to message queue 402-N. In certain embodiments, each message queue 402 may be implemented as a data element (e.g., a data table) in integration database 302.

Data messages written in message queues 402 may be provided to corresponding destinations by way of agents and additional message queues. For example, FIG. 4 illustrates agents 404 (e.g., agents 404-1 through 404-N.) communicatively coupled between message queues 402 and additional message queues 406 (e.g., message queues 406-1 through 406-N). Message queues 406 may be part of a message queue module 408, which may be configured to queue up and output data messages from data integration subsystem 104 to one or more backend data subsystems 102. In certain examples, message queue 402-1, agent 404-1, and message queue 406-1 may be associated with a particular backend data subsystem 102-1, message queue 402-2, agent 404-2, and message queue 406-2 may be associated with backend data subsystem 102-2, and message queue 402-N, agent 404-N, and message queue 406-N may be associated with backend data subsystem 102-N. In certain implementations, message queue 402-1, agent 404-1, and/or message queue 406-1 may be implemented within the backend-specific agent facility 206-1, message queue 402-2, agent 404-2, and/or message queue 406-2 may be implemented within the backend-specific agent facility 206-2, and message queue 402-N, agent 404-N, and/or message queue 406-N may be implemented within the backend-specific agent facility 206-N. Backend-specific agent facilities 206 may be configured to communicate with respective local agent facilities 204 of backend data subsystems 102-2 as described above, including transmitting data representative of queued destination-specific data messages to backend data subsystems 102.

Each agent 404 may be configured to retrieve data messages from a corresponding message queue 402, perform one or more operations on the retrieved data messages, and provide data representative of the processed data messages to a corresponding message queue 406 for subsequent transmission to a corresponding backend data subsystem 102. In this manner, updates to integrated data in integration database 302 may be propagated to local data maintained by backend data subsystems 102 in a way that is scalable and efficient. For example, high overhead operations such as writing output data to multiple destinations may be performed by the independent process independently of a trigger process such that the trigger process and/or other trigger processes of integration database 302 are not slowed by such high overhead operations. Accordingly, data integration subsystem 104 may be configured to synchronize data between data integration subsystem 104 and myriad backend data subsystems 102, without adversely affecting the performance of integration database 302 of data integration subsystem 104.

The scalable configuration shown in FIGS. 3 and 4 may facilitate convenient addition of one or more additional backend data subsystems to system 100. For example, when a new backend data subsystem is to be added to system 100, one or more rules in rules repository 310 may be added and/or modified to account for the new backend data subsystem. The rules may be added and/or modified dynamically during runtime without having to interrupt normal operation of integration database 302. The independent process may then consider the updated rules when determining how to process general data messages detected in general message repository. The addition and/or modification of the rules will not increase the complexity of a trigger process executed by trigger process facility 304. Accordingly, the efficiency of integration database 302 may be maintained.

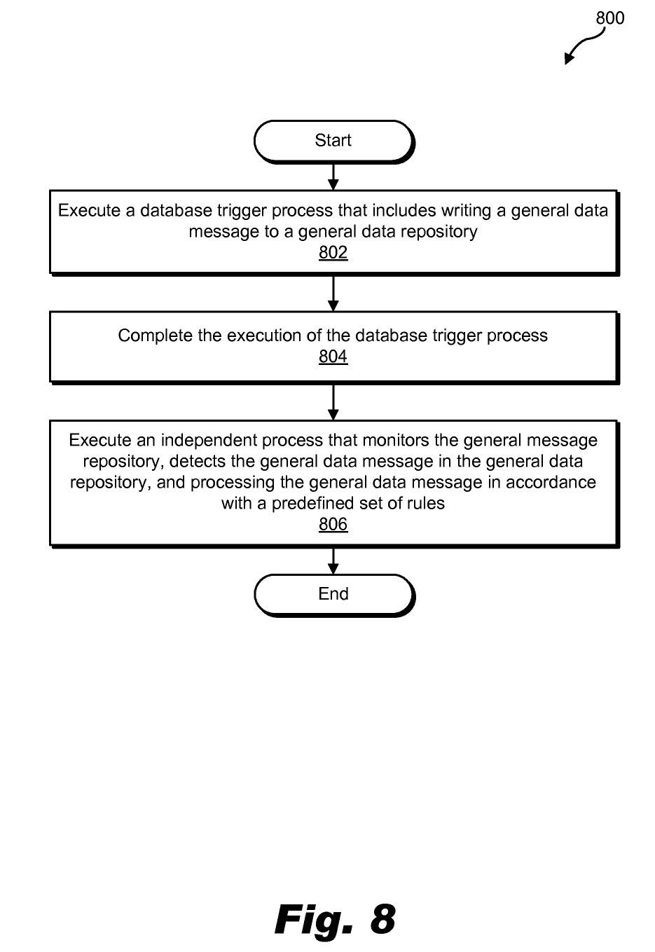

FIG. 8 illustrates an exemplary data processing method 800. While FIG. 8 illustrates exemplary steps according to one embodiment, other embodiments may omit, add to, reorder, combine, and/or modify any of the steps shown in FIG. 8. In certain embodiments, one or more of the steps shown in FIG. 8 may be performed by one or more components of system 100.

In step 802, a database trigger process may be executed. As described above, the database trigger process may be executed in response to a database trigger event and may include writing a general data message to a general message repository.

In step 804, the execution of the database trigger process may be completed. Step 804 may be accomplished in any suitable way. As described above, the execution of the database trigger process may be completed directly following the writing of the general data message to the general data repository in step 802.

In step 806, an independent process may be executed. As described above, the independent process may include monitoring the general message repository, detecting the general data message in the general data repository, and processing, in response to the detection of the general data message in the general data repository, the general data message in accordance with a predefined set of rules.

The processing of the general data message in accordance with the predefined set of rules in step 806 may include performing one or more operations that may be defined as may suit a particular implementation. For example, the processing may include checking data integrity of the general data message in accordance with one or more data integrity checking rules when the general data message is an incoming message. The rules to be applied to incoming messages may also specify a data format to be used in association with the incoming message and/or processing of the incoming message. For instance, the rules may specify an XML, pipelined, comma-separated, or other suitable format associated with the incoming message. As another example, the processing may include determining one or more destinations for the general data message when the general data message is an outgoing data message. As another example, the processing of the general data message may include generating a destination-specific data message based on the general data message and on one or more routing rules when the general data message is an outgoing data message.

One or more steps shown in FIG. 8 may be repeated for one or more additional database trigger processes. For example, steps 802 and 804 may be repeated for each new database trigger process that is triggered by one or more database trigger events. Steps 802 and 804 may be performed independently of step 806 such that one or more database trigger processes may be executed and completed independently of step 806. For example, a second database trigger process may be executed and completed in steps 802 and 804 before the execution of the independent process associated with the first database trigger process is completed in step 806.

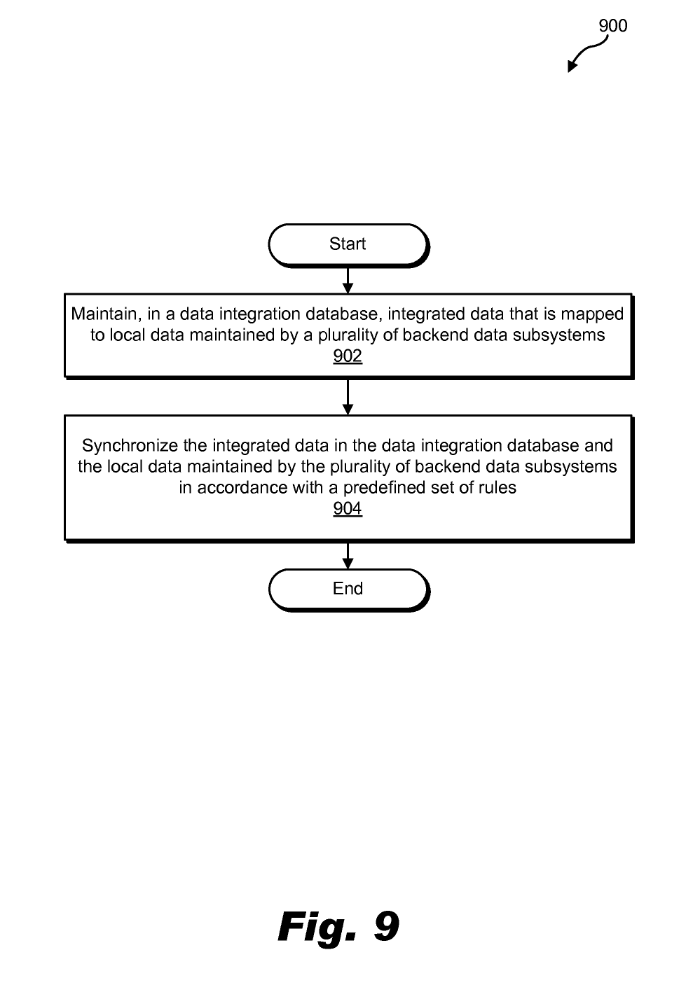

FIG. 9 illustrates an exemplary data integration method 900. While FIG. 9 illustrates exemplary steps according to one embodiment, other embodiments may omit, add to, reorder, combine, and/or modify any of the steps shown in FIG. 9. In certain embodiments, one or more of the steps shown in FIG. 9 may be performed by one or more components of system 100.

In step 902, integrated data may be maintained in a data integration database. As described above, the integrated data may be mapped to local data maintained by a plurality of backend data subsystems.

In step 904, the integrated data in the data integration database and the local data maintained by the plurality of backend data subsystems may be synchronized in accordance with a predefined set of rules. In certain implementations, step 904 may include performing one or more steps of method 800 shown in FIG. 8. Accordingly, integrated data and local data may be synchronized in a scalable, rules-based manner without adversely impacting the performance of one or more databases that maintain the data.

In certain embodiments, one or more of the components and/or processes described herein may be implemented and/or performed by one or more appropriately configured computing devices. To this end, one or more of the systems and/or components described above may include or be implemented as one or more computing systems (e.g., a data integration computing subsystem 104) and/or components by any computer hardware, computer-implemented instructions (e.g., software) embodied in a non-transitory computer-readable medium, or combinations of computer-implemented instructions and hardware, configured to execute one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

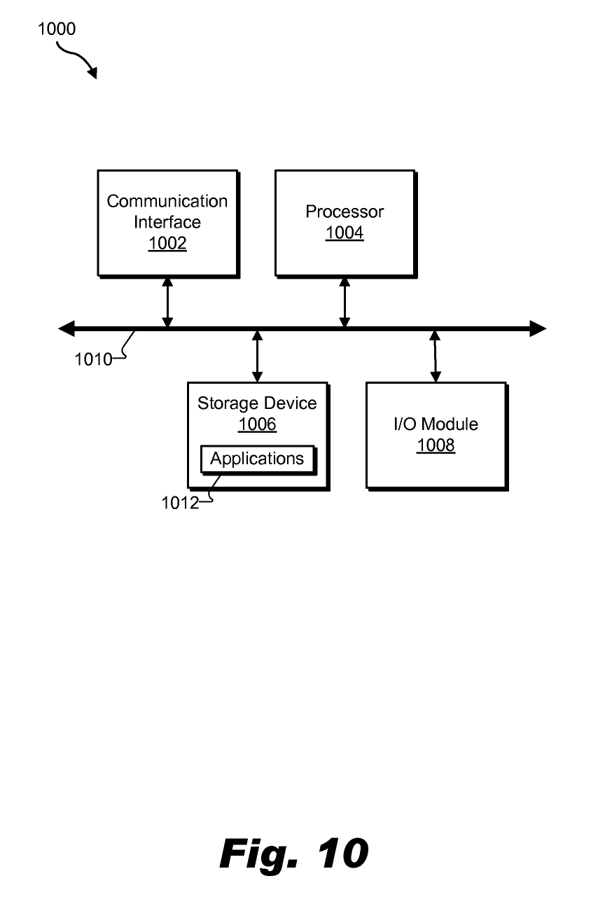

FIG. 10 illustrates an exemplary computing device 1000 that may be configured to perform one or more of the processes described herein. As shown in FIG. 10, computing device 1000 may include a communication interface 1002, a processor 1004, a storage device 1006, and an input/output (“I/O”) module 1008 communicatively connected via a communication infrastructure 1010. While an exemplary computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, and any other suitable interface. In at least one embodiment, communication interface 1002 may provide a direct connection between system 100 and one or more of provisioning systems via a direct link to a network, such as the Internet. Communication interface 1002 may additionally or alternatively provide such a connection through, for example, a local area network (such as an Ethernet network), a personal area network, a telephone or cable network, a satellite data connection, a dedicated URL, or any other suitable connection. Communication interface 1002 may be configured to interface with any suitable communication media, protocols, and formats, including any of those mentioned above.

Processor 1004 generally represents any type or form of processing unit capable of processing data or interpreting, executing, and/or directing execution of one or more of the instructions, processes, and/or operations described herein. Processor 1004 may direct execution of operations in accordance with one or more applications 1012 or other computer-executable instructions such as may be stored in storage device 1006 or another computer-readable medium.

Storage device 1006 may include one or more data storage media, devices, or configurations and may employ any type, form, and combination of data storage media and/or device. For example, storage device 1006 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1006. For example, data representative of one or more executable applications 1012 (which may include, but are not limited to, one or more of the software applications described herein) configured to direct processor 1004 to perform any of the operations described herein may be stored within storage device 1006. In some examples, data may be arranged in one or more databases residing within storage device 1006.

I/O module 1008 may be configured to receive user input and provide user output and may include any hardware, firmware, software, or combination thereof supportive of input and output capabilities. For example, I/O module 1008 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1008 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1000. For example, one or more applications 1012 residing within storage device 1006 may be configured to direct processor 1004 to perform one or more processes or functions associated with backend data subsystems 102, data integration subsystem 104, portal subsystem 106, or any components thereof.

In certain implementations, one or more of the processes and/or operations described herein may be performed at a physical computing layer. For example, checking integrity and/or routing of data messages may be associated with the physical layer. As a specific example, writing of data may include writing data to a non-transitory computer-readable medium at the physical layer.

While certain principles have been described herein in reference to a data integration implementation, the examples are illustrative only. The principles may be used in other data synchronization systems. For example, any separate databases may be synchronized using one or more of the principles described herein.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A method comprising:
executing, by at least one computing device, a database trigger process in response to a database trigger event, the database trigger process including writing a general data message to a general message repository; and
executing, by the at least one computing device, an independent process including
monitoring the general message repository,
detecting the general data message in the general message repository, and
processing, in response to the detecting of the general data message in the general message repository, the general data message in accordance with a predefined set of rules.

2. The method of claim 1, further comprising completing, by the at least one computing device, the executing of the database trigger process directly following the writing of the general data message to the general message repository.

3. The method of claim 1, wherein the database trigger process includes no processing steps other than the writing of the general data message to the general message repository.

4. The method of claim 1, wherein:
the database trigger process is associated with a specific data element in a database; and
the method further comprises executing, by the at least one computing device before completion of the independent process, an additional database trigger process associated with the specific data element in the database in response to an additional database trigger event, the additional database trigger process including writing an additional general data message to the general message repository.

5. The method of claim 1, wherein the independent process is a background process executed independently of the database trigger process.

6. The method of claim 1, wherein:
the independent process is implemented as a stored procedure of a database; and
the predefined set of rules are maintained in a data element in the database.

7. The method of claim 1, wherein the database trigger process has a constant overhead.

8. The method of claim 1, wherein:
the general data message comprises an incoming data message;
the predefined set of rules comprises one or more data integrity checking rules; and
the processing of the general data message in accordance with the predefined set of rules comprises checking data integrity of the incoming data message in accordance with the one or more data integrity checking rules.

9. The method of claim 1, wherein:
the general data message comprises an outgoing data message;
the predefined set of rules comprises one or more routing rules; and
the processing of the general data message in accordance with the predefined set of rules comprises determining one or more destinations for the outgoing data message.

10. The method of claim 9, wherein the one or more destinations comprise one or more backend data subsystems.

11. The method of claim 9, wherein the processing of the general data message in accordance with the predefined set of rules further comprises:
generating one or more destination-specific data messages for the one or more destinations based on the outgoing data message in the general message repository and on the one or more routing rules; and
writing the one or more destination-specific messages to one or more destination-specific message queues corresponding to the one or more destinations.

12. The method of claim 11, wherein the writing of the one or more destination-specific messages to the one or more destination-specific message queues is performed at a physical computing layer.

13. The method of claim 1, embodied as computer-executable instructions on at least one non-transitory computer-readable medium.

14. A method comprising:
maintaining, by a data integration computing subsystem in a data integration database, integrated data that is mapped to local data maintained by a plurality of backend data subsystems; and
synchronizing, by the data integration computing subsystem, the integrated data in the data integration database and the local data maintained by the plurality of backend data subsystems in accordance with a predefined set of rules;
wherein the synchronizing comprises
executing, by the data integration computing subsystem in response to a database trigger event, a database trigger process associated with the data integration database, the database trigger process including writing a general data message to a general message repository, and
executing, by the data integration computing subsystem, an independent process including
monitoring the general message repository,
detecting the general data message in the general message repository, and
processing, in response to the detecting of the general data message in the general message repository, the general data message in accordance with the predefined set of rules.

15. The method of claim 14, wherein the synchronizing further comprises completing, by the data integration computing subsystem, the executing of the database trigger process directly following the writing of the general data message to the general message repository.

16. The method of claim 14, wherein the database trigger process includes no processing steps other than the writing of the general data message to the general message repository.

17. The method of claim 14, wherein the independent process is a background process executed independently of the database trigger process.

18. The method of claim 14, wherein:
the general data message comprises an incoming data message;
the predefined set of rules comprises one or more data integrity checking rules; and
the processing of the general data message in accordance with the predefined set of rules comprises checking data integrity of the incoming data message in accordance with the one or more data integrity checking rules.

19. The method of claim 14, wherein:
the general data message comprises an outgoing data message;
the predefined set of rules comprises one or more routing rules; and
the processing of the general data message in accordance with the predefined set of rules comprises determining one or more destinations for the outgoing data message.

20. The method of claim 14, embodied as computer-executable instructions on at least one non-transitory computer-readable medium.

21. A system comprising:
a data integration computing subsystem configured to
maintain integrated data that is mapped to local data maintained by a plurality of backend data subsystems,
synchronize the integrated data and the local data in accordance with a predefined set of rules;
an integration database within the data integration computing subsystem;
a database trigger process facility associated with the integration database and configured to execute a database trigger process in response to a database trigger event, the database trigger process including writing a general data message to a general message repository; and
an independent process facility configured to execute a background process independently of the database trigger process, the background process including
monitoring the general message repository,
detecting the general data message in the general message repository, and
processing, in response to the detecting of the general data message in the general message repository, the general data message in accordance with the predefined set of rules.

22. The system of claim 21, wherein:
the background process is implemented as a stored procedure in the integration database; and
the predefined set of rules are maintained as a data element in the integration database.

23. The system of claim 21, wherein the database trigger process has a constant overhead.
